(19) United States
(12) Patent Application Publication
(10) Pub. No.: US 2025/0305510 A1
(43) Pub. Date: Oct. 2, 2025

(54) PUMP

(71) Applicant: NIDEC POWERTRAIN SYSTEMS CORPORATION, Kanagawa (JP)

(72) Inventors: Yoshiyuki SHIZUKU, Kanagawa (JP); Thao LETHITHANH, Kanagawa (JP); Tomofumi FURUKAWA, Kanagawa (JP)

(21) Appl. No.: 19/093,252

(22) Filed: Mar. 28, 2025

(30) Foreign Application Priority Data
Mar. 29, 2024 (JP) 2024-057201

(51) Int. Cl. F04D 29/22; F04D 1/00; F04D 29/42; H02K 21/16

(52) U.S. Cl. CPC F04D 29/22; F04D 1/00; F04D 29/4293; H02K 21/16

(57) ABSTRACT

A pump includes: a rotor rotatable about a central axis; a stator that radially faces the rotor with a gap interposed therebetween; an impeller connected to one side of the rotor in an axial direction; a housing that includes a rotor accommodating portion that accommodates the rotor therein; and a fixed shaft that extends in the axial direction and rotatably supports the rotor. The housing includes a rotor supporting portion that supports the rotor from one side in the axial direction, an impeller accommodating portion that accommodates the impeller therein and has an interior connected to an interior of the rotor accommodating portion, and a first suction port that is open to the interior of the impeller accommodating portion. The impeller includes a second suction port that is open to one side in the axial direction. A part of the fixed shaft is exposed to the second suction port.

### CROSS-REFERENCE TO RELATED APPLICATIONS

The present invention claims priority under 35 U.S.C. § 119 to Japanese Patent Application No. 2024-057201 filed on Mar. 29, 2024, the entire content of which is incorporated herein by reference.

### FIELD OF THE INVENTION

The present invention relates to a pump.

### BACKGROUND

Hitherto, there has been known a pump including a rotor that rotates about a support shaft that is a fixed shaft.

In the pump as described above, there is a problem that heat is generated due to friction between the fixed shaft and the rotor. Therefore, for the pump as described above, an improvement in heat dissipation of the fixed shaft has been demanded.

### SUMMARY

One aspect of a pump according to the present invention includes: a rotor that is rotatable about a central axis; a stator that radially faces the rotor with a gap interposed therebetween; an impeller that is connected to one side of the rotor in an axial direction; a housing that includes a rotor accommodating portion that accommodates the rotor therein; and a fixed shaft that extends in the axial direction and rotatably supports the rotor. The housing includes a rotor supporting portion that supports the rotor from one side in the axial direction, an impeller accommodating portion that accommodates the impeller therein and has an interior connected to an interior of the rotor accommodating portion, and a first suction port that is open to the interior of the impeller accommodating portion. The impeller includes a second suction port that is open to one side in the axial direction. A part of the fixed shaft is exposed to the second suction port.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view showing a pump in a first embodiment;

FIG. 2 is a cross-sectional view showing the pump in the first embodiment, and is a cross-sectional view taken along line II-II in FIG. 3;

FIG. 3 is a cross-sectional view showing the pump in the first embodiment;

FIG. 4 is a perspective view showing a part of a bearing portion in the first embodiment;

FIG. 5 is a cross-sectional view showing a part of the pump in the first embodiment;

FIG. 6 is a perspective view showing a part of a fixed shaft and a washer in the first embodiment;

FIG. 7 is a cross-sectional view showing a second housing and an impeller in the first embodiment;

FIG. 8 is a perspective view showing the second housing in the first embodiment;

FIG. 9 is a cross-sectional view showing another part of the pump in the first embodiment;

FIG. 10 is a cross-sectional view showing a part of a procedure for fixing the first housing and the second housing to each other by welding in the first embodiment;

FIG. 11 is a cross-sectional view showing a part of a pump in a second embodiment; and

FIG. 12 is a cross-sectional perspective view showing a part of a pump in a third embodiment.

### DETAILED DESCRIPTION

Each figure virtually shows a central axis J in a pump according to an embodiment described below. In the following description, an axial direction of the central axis J is simply referred to an “axial direction”, a radial direction with the central axis J as a center is simply referred to a “radial direction”, and a circumferential direction with the central axis J as a center is simply referred to a “circumferential direction”. A Z axis shown in each figure indicates a direction in which the central axis J extends. In the description below, a side (+Z side) of the axial direction to which an arrow of the Z axis is directed is referred to as an “upper side”, and a side (−Z side) of the axial direction that is opposite to the side to which the arrow of the Z axis is directed is referred to as a “lower side”.

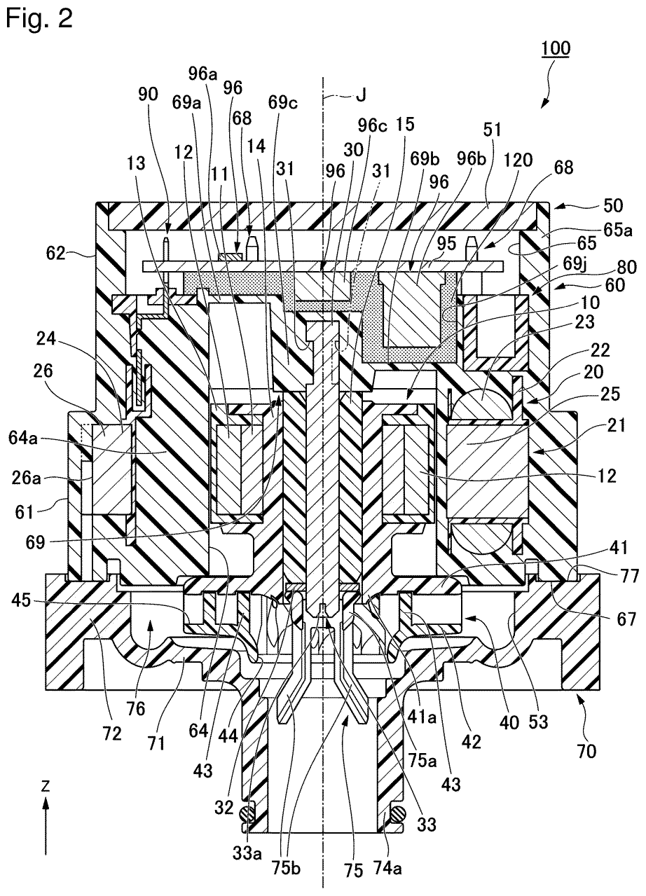

In the embodiments below, the upper side corresponds to “one side in the axial direction”, and the lower side corresponds to the “other side in the axial direction”. The upper side and the lower side are simply terms for describing a relative positional relationship of each part, and thus an actual placement relationship and the like may be a placement relationship and the like other than the placement relationship and the like indicated by these terms. Further, in FIG. 2, for the sake of explanation, cross sections at different positions in the circumferential direction are shown on both the left and right sides of the central axis J.

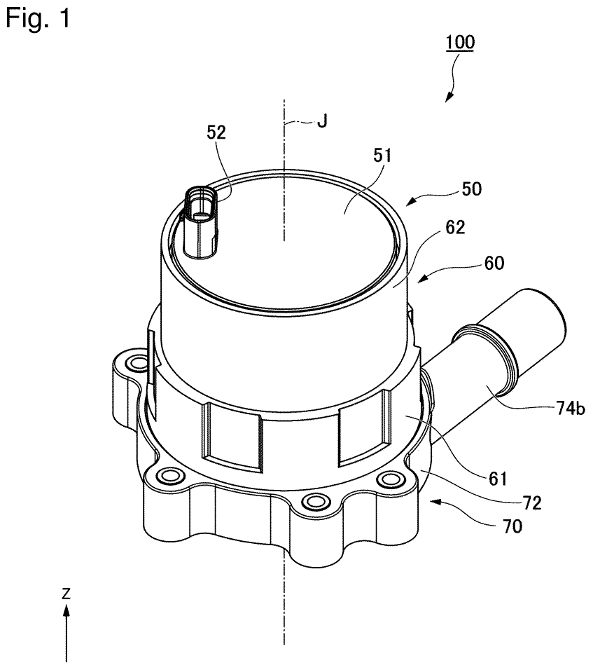

A pump 100 according to the present embodiment shown in FIGS. 1 and 2 is a water pump that sends water W. As shown in FIG. 2, the pump 100 according to the present embodiment includes a rotor 10, a stator 20, a fixed shaft 30, an impeller 40, a housing 50, a holding member 80, a conductive member 90, a board 95, and a plurality of electronic components 96. The housing 50 includes a first housing 60 made of a resin, a second housing 70, and a lid member 51.

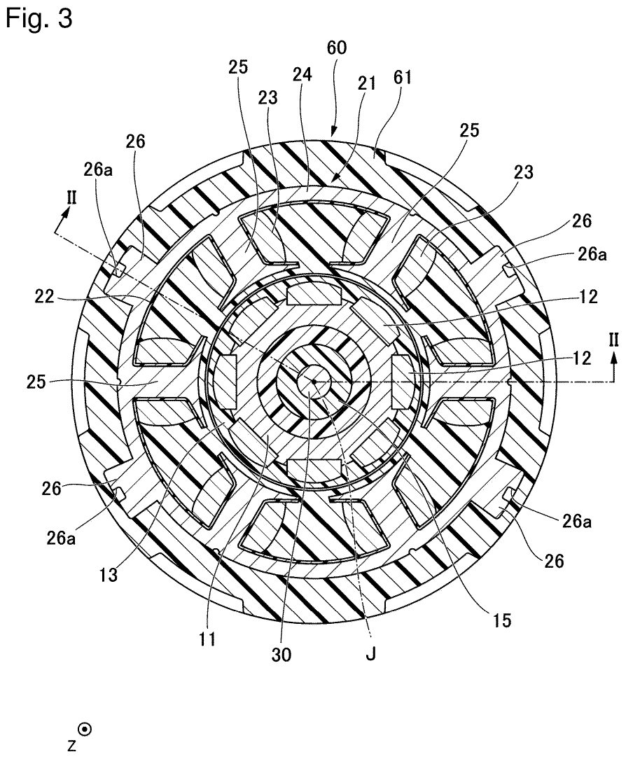

The rotor 10 is rotatable about the central axis J. The rotor 10 includes a rotor core 11, a magnet 12, a first resin portion 13, a second resin portion 14, and a bearing portion 15. As shown in FIG. 3, the rotor core 11 has an annular shape surrounding the central axis J. The magnet 12 is fixed to a radially outer surface of the rotor core 11. A plurality of magnets 12 are provided at intervals in the circumferential direction. In the present embodiment, eight magnets 12 are provided.

The first resin portion 13 has a substantially cylindrical shape surrounding the central axis J and extending in the axial direction. As shown in FIG. 2, the first resin portion 13 covers the rotor core 11 and the plurality of magnets 12 from an outer side in the radial direction and both sides in the axial direction. The rotor core 11 and the plurality of magnets 12 are embedded in the first resin portion 13. In the present embodiment, the first resin portion 13 is formed by insert molding using the rotor core 11 and the plurality of magnets 12 as insert members.

The second resin portion 14 has a substantially cylindrical shape surrounding the central axis J and extending in the axial direction. The second resin portion 14 is positioned on an inner side of the rotor core 11 in the radial direction. The second resin portion 14 covers a radially inner surface of the rotor core 11. The second resin portion 14 has portions sandwiching the first resin portion 13 in the axial direction. The second resin portion 14 is fixed to the first resin portion 13. In the present embodiment, the second resin portion 14 is formed by insert molding using a molded body integrally molded by insert molding and including the rotor core 11, the plurality of magnets 12, and the first resin portion 13, and the bearing portion 15 as insert members.

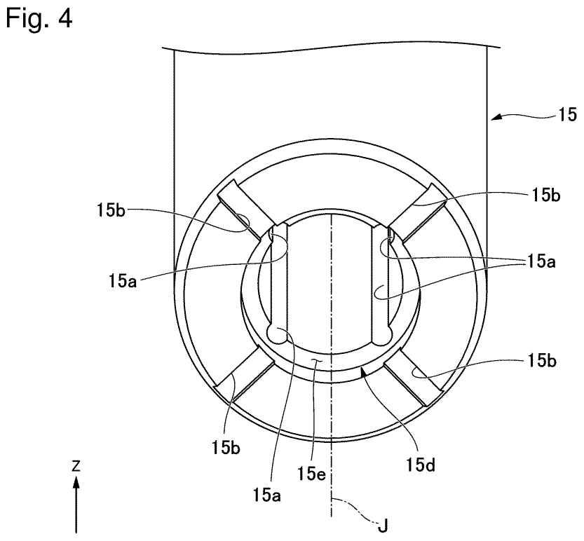

The bearing portion 15 has a tubular shape through which the fixed shaft 30 passes in the axial direction. In the present embodiment, the bearing portion 15 has a substantially cylindrical shape surrounding the central axis J and extending in the axial direction. The bearing portion 15 is a portion rotatably supported by the fixed shaft 30. The bearing portion 15 is positioned on an inner side of the second resin portion 14 in the radial direction. An outer circumferential surface of the bearing portion 15 is fixed to an inner circumferential surface of the second resin portion 14. The bearing portion 15 is made of, for example, a resin. The bearing portion 15 is open on both sides in the axial direction. As shown in FIG. 4, a stepped portion 15d having a stepped surface 15e facing downward is provided on an inner circumferential surface at a lower end portion of the bearing portion 15. The stepped surface 15e has a substantially annular shape surrounding the central axis J. The stepped surface 15e is, for example, orthogonal to the axial direction. An inner diameter of a portion of the bearing portion 15 that is positioned below the stepped surface 15e is larger than an inner diameter of a portion of the bearing portion 15 at which the stepped surface 15e is provided.

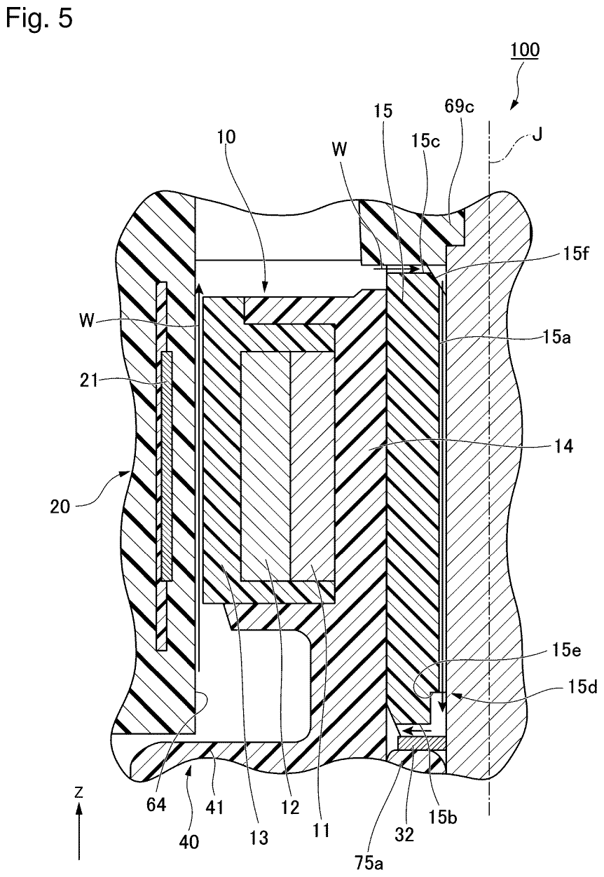

As shown in FIG. 5, an inner circumferential surface at an upper end portion of the bearing portion 15 is an inclined surface 15f. The inclined surface 15f has an annular shape surrounding the central axis J, and has an inner diameter increasing toward an upper side. The inclined surface 15f has the same shape as an outer circumferential surface of a truncated cone whose outer diameter increases toward the upper side.

A first groove portion 15a that is open on both sides in the axial direction is provided on an inner surface of the bearing portion 15. The first groove portion 15a extends in the axial direction. More specifically, the first groove portion 15a extends from a lower end portion of the inclined surface 15f to the stepped surface 15e. An upper end portion of the first groove portion 15a is open to the inclined surface 15f. A lower end portion of the first groove portion 15a is open to the stepped surface 15e. As shown in FIG. 4, an inner surface of the first groove portion 15a has a semicircular arc shape recessed radially outward in a cross section orthogonal to the axial direction. A plurality of first groove portions 15a are provided at intervals in the circumferential direction. In the present embodiment, four first groove portions 15a are provided. In the present embodiment, the plurality of first groove portions 15a are arranged at equal intervals over the entire circumference in the circumferential direction.

A second groove portion 15b extending from an inner circumferential surface of the bearing portion 15 to the outer circumferential surface of the bearing portion 15 is provided on a lower end surface of the bearing portion 15. In the present embodiment, the second groove portion 15b extends linearly in the radial direction. A plurality of second groove portions 15b are provided at intervals in the circumferential direction. In the present embodiment, four second groove portions 15b are provided. In the present embodiment, the plurality of second groove portions 15b are arranged at equal intervals over the entire circumference in the circumferential direction. An interior of the second groove portion 15b is directly or indirectly connected to an interior of the first groove portion 15a. In the present embodiment, the interior of the second groove portion 15b is indirectly connected to the interior of the first groove portion 15a via a portion of an internal space of the bearing portion 15 that is positioned below the stepped surface 15e. More specifically, a radially inner end portion in the interior of the second groove portion 15b is indirectly connected to the lower end portion of the first groove portion 15a via the portion of the internal space of the bearing portion 15 that is positioned below the stepped surface 15e. The interior of the second groove portion 15b may be directly connected to the interior of the first groove portion 15a.

As shown in FIG. 5, a third groove portion 15c extending from the inner circumferential surface of the bearing portion 15 to the outer circumferential surface of the bearing portion 15 is provided on an upper end surface of the bearing portion 15. The third groove portion 15c is similar to the second groove portion 15b except that the third groove portion 15c is provided on the upper end surface of the bearing portion 15.

As shown in FIG. 2, the stator 20 faces the rotor 10 in the radial direction with a gap interposed therebetween. More specifically, the stator 20 faces the rotor 10 in the radial direction with a part of the resin forming the first housing 60 and a gap interposed therebetween. In the present embodiment, the stator 20 is positioned radially outside the rotor 10. The stator 20 surrounds the rotor 10. At least a part of the stator 20 is embedded and held in the first housing 60. In the present embodiment, the entire stator 20 is embedded in the first housing 60. The stator 20 includes a stator core 21, an insulator 22 attached to the stator core 21, and a plurality of coils 23 attached to the stator core 21 with the insulator 22 interposed therebetween.

The stator core 21 is positioned radially outside the rotor core 11 and the plurality of magnets 12, and surrounds the rotor core 11 and the plurality of magnets 12. The stator core 21 is formed by, for example, stacking a plurality of plate members in the axial direction. The plurality of plate members forming the stator core 21 are, for example, electromagnetic steel plates. At least a part of the stator core 21 is embedded and held in the first housing 60 made of a resin. In the present embodiment, the entire stator core 21 is embedded in the first housing 60. As shown in FIG. 3, the stator core 21 includes an annular core back 24 surrounding the rotor 10, a plurality of teeth 25 extending radially inward from the core back 24, and a protrusion 26 protruding radially outward from the core back 24.

The core back 24 has a substantially annular shape around the central axis J. A radial dimension between an inner circumferential surface and an outer circumferential surface of the core back 24, that is, a thickness of the core back 24 in the radial direction is smaller than a circumferential dimension of a portion of the tooth 25 connected to the core back 24, that is, a radially outer end portion of the tooth 25. The plurality of teeth 25 are arranged at intervals in the circumferential direction. More specifically, the plurality of teeth 25 are arranged at equal intervals over the entire circumference in the circumferential direction. In the present embodiment, six teeth 25 are provided.

The protrusion 26 has a substantially trapezoidal shape whose circumferential dimension increases toward an outer side in the radial direction when viewed in the axial direction. In the present embodiment, an axial dimension of the protrusion 26 is the same as an axial dimension of the core back 24 and an axial dimension of the tooth 25. The protrusion 26 has a core recess 26a recessed radially inward from a radially outer surface of the protrusion 26. In the present embodiment, the core recess 26a is a groove that extends in the axial direction and is open on both sides in the axial direction. An interior of the core recess 26a has a substantially rectangular shape when viewed in the axial direction. The core recess 26a is provided at the center of the radially outer surface of the protrusion 26 in the circumferential direction. As shown in FIG. 2, an upper portion in the interior of the core recess 26a is filled with the resin forming the first housing 60. A lower portion in the interior of the core recess 26a is a void portion that is not filled with the resin.

As shown in FIG. 3, a plurality of protrusions 26 are provided at intervals in the circumferential direction. In the present embodiment, four protrusions 26 are provided. Each of the protrusions 26 is connected to a portion of the core back 24 positioned between the teeth 25 adjacent to each other in the circumferential direction. Therefore, even in a case where the protrusion 26 is provided, a flow of a magnetic flux between the core back 24 and the teeth 25 can be hardly inhibited. Each of the protrusions 26 is connected to a circumferential central portion of each portion of the core back 24 positioned between the teeth 25 adjacent to each other in the circumferential direction. The four protrusions 26 include a pair of protrusions 26 disposed with one tooth 25 interposed therebetween in the circumferential direction and a pair of protrusions 26 disposed with another tooth 25 interposed therebetween in the circumferential direction. The tooth 25 positioned between one pair of protrusions 26 in the circumferential direction and the tooth 25 positioned between the other pair of protrusions 26 in the circumferential direction are disposed with the central axis J interposed therebetween in the radial direction. The plurality of coils 23 are attached to the plurality of teeth 25 via the insulator 22. The plurality of coils 23 are electrically connected to the board 95 via the conductive member 90.

As shown in FIG. 2, the fixed shaft 30 extends in the axial direction. More specifically, the fixed shaft 30 has a substantially columnar shape extending in the axial direction around the central axis J. The fixed shaft 30 is positioned on an inner side of the bearing portion 15 in the radial direction in the rotor 10. The fixed shaft 30 passes in the axial direction on the inner side of the bearing portion 15 in the radial direction. The fixed shaft 30 protrudes to both sides in the axial direction from the bearing portion 15. The fixed shaft 30 is fitted with a gap on the inner side of the bearing portion 15 in the radial direction. The fixed shaft 30 rotatably supports the rotor 10 by supporting the inner circumferential surface of the bearing portion 15.

An upper end portion of the fixed shaft 30 is embedded and held in a shaft holding portion 69c described below in the first housing 60. The fixed shaft 30 extends downward from the shaft holding portion 69c. A lower end portion of the fixed shaft 30 is positioned below a rotor accommodating portion 64 described below. A pair of shaft recesses 31 arranged so as to sandwich the central axis J in the radial direction is provided at a portion of the fixed shaft 30 that is embedded in the shaft holding portion 69c. Since a part of a resin forming the shaft holding portion 69c is positioned in the pair of shaft recesses 31, the fixed shaft 30 is prevented from being detached from the shaft holding portion 69c.

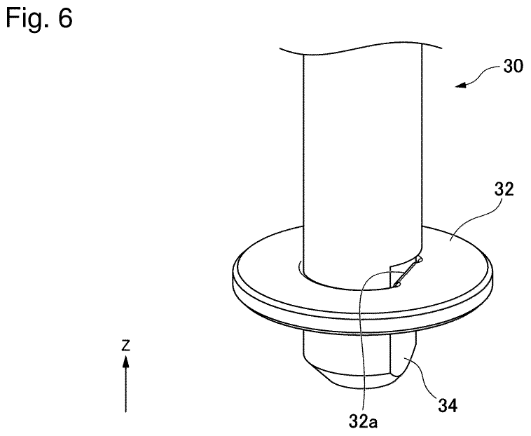

The fixed shaft 30 has a recess 33. The recess 33 is provided at a portion of the fixed shaft 30 that is exposed to a second suction port 44 described below. In the present embodiment, the recess 33 is recessed upward from a lower end surface of the fixed shaft 30. The recess 33 has, for example, a circular shape centered on the central axis J when viewed in the axial direction. A lower portion of the recess 33 is a tapered portion 33a. An inner diameter of the tapered portion 33a increases toward a lower side. An inner surface of the tapered portion 33a has the same shape as an outer circumferential surface of a truncated cone whose outer diameter increases toward the lower side. As shown in FIG. 6, a flat surface 34 is provided at a lower end portion of an outer circumferential surface of the fixed shaft 30. The flat surface 34 is a flat surface orthogonal to the radial direction. The flat surface 34 is a flat surface formed by D-cutting the lower end portion of the fixed shaft 30. The flat surface 34 is positioned on a radially inner side of an outer circumferential surface of a portion of the fixed shaft 30 that is positioned above the flat surface 34 and an arc-shaped surface connected to the flat surface 34 in the circumferential direction.

As shown in FIG. 2, the impeller 40 is connected to a lower side of the rotor 10. When the rotor 10 rotates about the central axis J, the impeller 40 rotates about the central axis J. The impeller 40 is made of a resin. The impeller 40 includes a base portion 41, a shroud portion 42, and a plurality of blade portions 43. In the present embodiment, the base portion 41 is connected to a lower end portion of the second resin portion 14. The second resin portion 14 and the base portion 41 are parts of the same single member. The base portion 41 is formed simultaneously when the second resin portion 14 is formed by insert molding. The base portion 41 has an annular shape surrounding the central axis J. In the present embodiment, the base portion 41 has a substantially annular shape centered on the central axis J. A radially inner edge portion 41a of the base portion 41 protrudes downward from a portion of the base portion 41 that is positioned radially outside the radially inner edge portion 41a. The radially inner edge portion 41a has a cylindrical shape that is open downward. An outer diameter of the radially inner edge portion 41a decreases toward a lower side. An interior of the radially inner edge portion 41a is connected to a lower end portion of an interior of the second resin portion 14. An outer diameter of the base portion 41 is larger than an outer diameter of the lower end portion of the second resin portion 14.

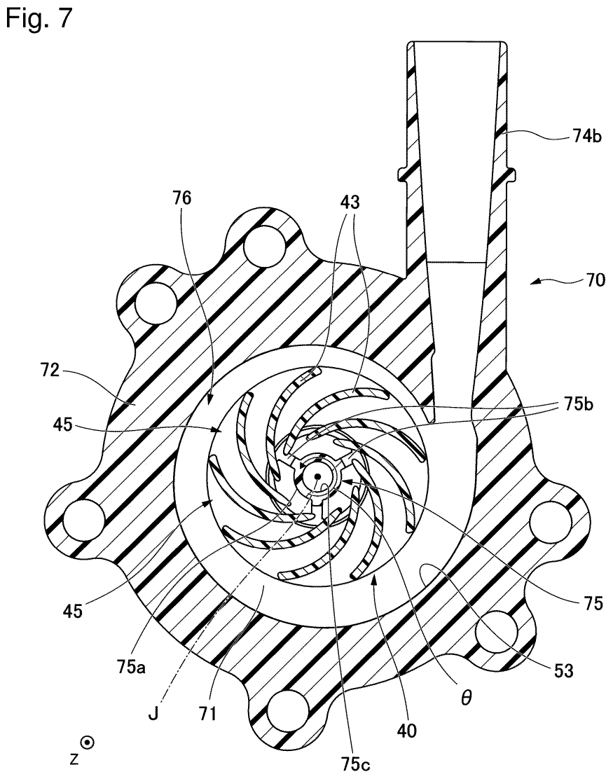

In the present embodiment, the shroud portion 42 is separate from the base portion 41. The shroud portion 42 is disposed below the base portion 41 while being spaced apart from the base portion 41. The shroud portion 42 has an annular shape centered on the central axis J. The plurality of blade portions 43 are positioned between the base portion 41 and the shroud portion 42 in the axial direction. As shown in FIG. 7, the plurality of blade portions 43 are arranged at intervals in the circumferential direction. The plurality of blade portions 43 are positioned on a side (−θ side) opposite to a side (+θ side) to which the rotating impeller 40 advances in the circumferential direction toward an outer side in the radial direction. An arrow θ shown in FIG. 7 indicates a direction in which the impeller 40 rotates together with the rotor 10. The side to which the arrow θ is directed (+θ side) is the side to which the rotating impeller 40 advances. The plurality of blade portions 43 are curved when viewed in the axial direction. As shown in FIG. 2, lower end portions of the plurality of blade portions 43 are connected to the shroud portion 42. In the present embodiment, the shroud portion 42 and the plurality of blade portions 43 are parts of the same single member. Upper end portions of the plurality of blade portions 43 are in contact with the base portion 41.

The impeller 40 includes the second suction port 44 that is open downward. The second suction port 44 is an opening on a lower side of the shroud portion 42. The second suction port 44 protrudes downward from a portion of the shroud portion 42 that is positioned radially outside the second suction port 44. The second suction port 44 has a cylindrical shape that is open downward. In the present embodiment, the second suction port 44 has a circular shape centered on the central axis J when viewed in the axial direction. An inner diameter of the second suction port 44 is larger than an inner diameter of the base portion 41 and an inner diameter of a first suction port 74a described below. The second suction port 44 is disposed to face an upper side of the first suction port 74a. An interior of the second suction port 44 is connected to an interior of the first suction port 74a.

The impeller 40 includes a second discharge port 45 that is open radially outward. As shown in FIG. 7, each second discharge port 45 is provided between radially outer end portions of the blade portions 43 adjacent to each other in the circumferential direction. The water W sucked into the impeller 40 from the first suction port 74a described below is discharged radially outward from the second discharge port 45.

As shown in FIG. 1, in the present embodiment, the first housing 60 is a substantially columnar member centered on the central axis J. As shown in FIG. 2, the first housing 60 includes the rotor accommodating portion 64 that accommodates the rotor 10 therein, a board accommodating portion 65 that accommodates the board 95 therein, and a partition portion 69 that partitions between an interior of the rotor accommodating portion 64 and an interior of the board accommodating portion 65. That is, the housing 50 includes the rotor accommodating portion 64, the board accommodating portion 65, and the partition portion 69.

The rotor accommodating portion 64 has a tubular shape that surrounds the central axis J and is open downward. In the present embodiment, the rotor accommodating portion 64 has a substantially cylindrical shape that is centered on the central axis J and is open downward. Among wall portions forming the rotor accommodating portion 64, a wall portion that is positioned on an upper side is formed by the partition portion 69. The rotor accommodating portion 64 includes a first circumferential wall portion 64a. The first circumferential wall portion 64a is a portion positioned radially outside the rotor 10 among the wall portions forming the rotor accommodating portion 64. The first circumferential wall portion 64a extends downward from a radially outer circumferential edge portion of the partition portion 69. The first circumferential wall portion 64a has a tubular shape that surrounds the central axis J and is open downward. More specifically, the first circumferential wall portion 64a has a substantially cylindrical shape that is centered on the central axis J and is open downward. The stator 20 is embedded in the first circumferential wall portion 64a.

The board accommodating portion 65 is positioned above the rotor accommodating portion 64. The board accommodating portion 65 has a tubular shape that surrounds the central axis J and is opened upward. Among wall portions forming the board accommodating portion 65, a wall portion that is positioned on a lower side is formed by the partition portion 69. The board accommodating portion 65 is a portion that accommodates the board 95 therein. The board accommodating portion 65 includes a second circumferential wall portion 65a as a circumferential wall portion surrounding the board 95 around the central axis J. The second circumferential wall portion 65a has a tubular shape that surrounds the central axis J and is opened upward. More specifically, the second circumferential wall portion 65a has a substantially cylindrical shape that is centered on the central axis J and is open upward.

A radially inner surface of the second circumferential wall portion 65a is positioned radially outside a radially inner surface of the first circumferential wall portion 64a. A thickness of the second circumferential wall portion 65a in the radial direction is smaller than a thickness of the first circumferential wall portion 64a in the radial direction. The thickness of the first circumferential wall portion 64a in the radial direction is equal to a distance between the radially inner surface of the first circumferential wall portion 64a and a radially outer surface of the first circumferential wall portion 64a in the radial direction. The thickness of the second circumferential wall portion 65a in the radial direction is equal to a distance between the radially inner surface of the second circumferential wall portion 65a and a radially outer surface of the second circumferential wall portion 65a in the radial direction. The lid member 51 is fixed to an upper end portion of the second circumferential wall portion 65a. The upper end portion of the second circumferential wall portion 65a is an upper end portion of the board accommodating portion 65. The lid member 51 closes an upper opening of the second circumferential wall portion 65a, that is, an upper opening of the board accommodating portion 65. As shown in FIG. 1, a connector portion 52 protruding upward is provided on the lid member 51.

As shown in FIG. 2, the partition portion 69 is positioned on a radially inner side of an upper end portion of the first circumferential wall portion 64a. A radially outer edge portion of the partition portion 69 is connected to a radially inner edge portion of the first circumferential wall portion 64a. The partition portion 69 covers the rotor 10 from above. The partition portion 69 includes a first partition portion 69a, a second partition portion 69b, and the shaft holding portion 69c. Although not shown, in the present embodiment, the shaft holding portion 69c has a substantially rectangular parallelepiped shape. The shaft holding portion 69c is disposed at a position through which the central axis J passes. The shaft holding portion 69c holds the upper end portion of the fixed shaft 30. In the present embodiment, the upper end portion of the fixed shaft 30 is embedded in the shaft holding portion 69c. The bearing portion 15 is positioned below the shaft holding portion 69c. FIG. 2 shows a state in which the upper end surface of the bearing portion 15 is in contact with a lower surface of the shaft holding portion 69c, but the present invention is not limited thereto. The upper end surface of the bearing portion 15 may be separated downward from the lower surface of the shaft holding portion 69c.

The first partition portion 69a and the second partition portion 69b are wall portions that separate the interior of the rotor accommodating portion 64 and the interior of the board accommodating portion 65 from each other in the axial direction. The first partition portion 69a and the second partition portion 69b are disposed at positions overlapping the interior of the rotor accommodating portion 64 and the interior of the board accommodating portion 65 when viewed in the axial direction. In the present embodiment, the first partition portion 69a and the second partition portion 69b are positioned radially outside the shaft holding portion 69c. The first partition portion 69a and the second partition portion 69b are connected to a radially outer edge portion of the shaft holding portion 69c. Positions of the first partition portion 69a and the second partition portion 69b in the circumferential direction are different from each other.

The second partition portion 69b is positioned below the first partition portion 69a. The second partition portion 69b is positioned below an upper end portion of the shaft holding portion 69c. The second partition portion 69b is positioned below the upper end portion of the fixed shaft 30. A radially inner edge portion of the second partition portion 69b is connected to a radially outer edge portion of a lower portion of the shaft holding portion 69c. In the present embodiment, the second partition portion 69b is positioned above a lower end portion of the shaft holding portion 69c.

A thickness of the first partition portion 69a in the axial direction and a thickness of the second partition portion 69b in the axial direction are smaller than the thickness of the second circumferential wall portion 65a in the radial direction. In the present embodiment, the thickness of the first partition portion 69a in the axial direction and the thickness of the second partition portion 69b in the axial direction are smaller than a thickness of the board 95. In the present embodiment, the thickness of the board 95 is an axial dimension of the board 95. In the present embodiment, the thickness of the first partition portion 69a in the axial direction and the thickness of the second partition portion 69b in the axial direction are the same as each other.

The thickness of the first partition portion 69a in the axial direction is, for example, uniform over the entire first partition portion 69a. The thickness of the second partition portion 69b in the axial direction is, for example, uniform over the entire second partition portion 69b. The first partition portion 69a may have portions having different thicknesses in the axial direction. The second partition portion 69b may have portions having different thicknesses in the axial direction.

As shown in FIG. 1, the first housing 60 includes a large-diameter housing portion 61 and a small-diameter housing portion 62 connected to an upper side of the large-diameter housing portion 61. A lower end portion of the large-diameter housing portion 61 is a lower end portion of the first housing 60. As shown in FIG. 2, an upper end portion of the large-diameter housing portion 61 is positioned above an upper end portion of the stator core 21. The large-diameter housing portion 61 is formed by a part of the first circumferential wall portion 64a. The lower end portion of the large-diameter housing portion 61 is a lower end portion of the first circumferential wall portion 64a. At least a part of the stator core 21 is embedded and held in the large-diameter housing portion 61. In the present embodiment, the entire stator core 21 is embedded in the large-diameter housing portion 61. An upper end portion of the small-diameter housing portion 62 is an upper end portion of the first housing 60. An outer diameter of the small-diameter housing portion 62 is smaller than an outer diameter of the large-diameter housing portion 61. The small-diameter housing portion 62 is formed by a part of the first circumferential wall portion 64a and the second circumferential wall portion 65a of the board accommodating portion 65.

A radially outer edge portion of a lower surface of the first housing 60 is a first welding fixing portion 67. The first welding fixing portion 67 is a portion fixed to the second housing 70 by welding. The first welding fixing portion 67 has an annular shape surrounding the central axis J. More specifically, the first welding fixing portion 67 has an annular shape centered on the central axis J.

As shown in FIG. 2, the second housing 70 is positioned below the first housing 60. The second housing 70 is fixed to the first housing 60. In the present embodiment, the second housing 70 is made of a resin. The second housing 70 includes an annular bottom wall portion 71 surrounding the central axis J and an annular wall portion 72 protruding upward from a radially outer edge portion of the bottom wall portion 71. The bottom wall portion 71 is positioned below the impeller 40. A radially outer end portion of the bottom wall portion 71 is positioned radially outside the impeller 40. The annular wall portion 72 has an annular shape that surrounds the central axis J and is open upward. The annular wall portion 72 is fixed to the first housing 60. A radially outer portion of an upper opening of the annular wall portion 72 is closed by the first housing 60 to form an impeller accommodating portion 53 that accommodates the impeller 40 therein. That is, the housing 50 includes the impeller accommodating portion 53. An interior of the impeller accommodating portion 53 is connected to the interior of the rotor accommodating portion 64. More specifically, an interior of a radially inner portion of the impeller accommodating portion 53 is positioned on a lower side of the interior of the rotor accommodating portion 64 and is connected to the interior of the rotor accommodating portion 64.

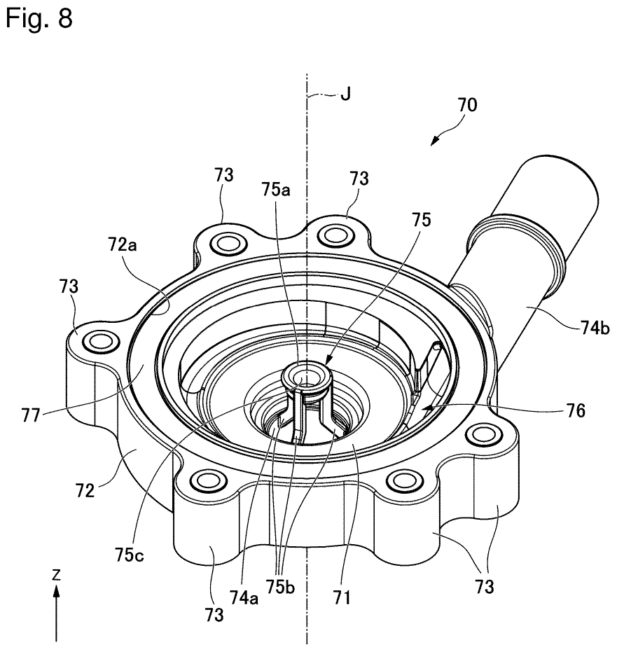

As shown in FIG. 8, the second housing 70 includes a plurality of fixing portions 73 protruding radially outward from the annular wall portion 72. The plurality of fixing portions 73 are arranged at intervals in the circumferential direction. The plurality of fixing portions 73 are portions fixed to a device to which the pump 100 is attached. Each fixing portion 73 is fixed to the device to which the pump 100 is attached by, for example, a bolt penetrating through each fixing portion 73 in the axial direction.

The second housing 70 includes the first suction port 74a and a flow path portion 76. That is, the housing 50 includes the first suction port 74a and the flow path portion 76. The first suction port 74a protrudes downward from a radially inner edge portion of the bottom wall portion 71. In the present embodiment, the first suction port 74a has a substantially cylindrical shape centered on the central axis J. The first suction port 74a is open downward. The first suction port 74a is open to the interior of the impeller accommodating portion 53. More specifically, an upper end portion of the first suction port 74a is open upward and is open to the interior of the impeller accommodating portion 53.

The flow path portion 76 is positioned radially outside the impeller 40. The flow path portion 76 is provided between the impeller 40 and the annular wall portion 72 in the radial direction. As shown in FIG. 7, the flow path portion 76 extends in the circumferential direction. In the present embodiment, the rotor 10 and the impeller 40 rotate in a counterclockwise direction about the central axis J when viewed from above. A flow path width of the flow path portion 76, that is, a radial dimension of the flow path portion 76 increases toward a front side (+θ side) in a rotation direction of the impeller 40. An interior of the flow path portion 76 is formed by a part of the interior of the impeller accommodating portion 53.

The second housing 70 includes a first discharge port 74b. The first discharge port 74b has a tubular shape extending from the annular wall portion 72 in a direction orthogonal to the axial direction. The first discharge port 74b is connected to a downstream end portion of the flow path portion 76. When the rotor 10 rotates and the impeller 40 rotates, the water W is sucked into the impeller 40 from the first suction port 74a. The water W sucked into the impeller 40 is discharged radially outward from the second discharge port 45 of the impeller 40, flows in the circumferential direction along the flow path portion 76, and is discharged from the first discharge port 74b to the outside of the pump 100. A part of the water W sucked from the first suction port 74a also flows into the rotor accommodating portion 64.

As shown in FIG. 5, the water W flowing into the rotor accommodating portion 64 flows upward between the rotor 10 and the stator 20 in the radial direction, and flows to an upper side of the rotor 10. More specifically, the water W flowing into the rotor accommodating portion 64 flows between a radially outer surface of the rotor 10 and a radially inner surface of the rotor accommodating portion 64, and flows to the upper side of the rotor 10. The water W flowing to the upper side of the rotor 10 flows radially inward through a gap between the bearing portion 15 and the shaft holding portion 69c in the axial direction or the third groove portion 15c, and flows into the bearing portion 15. The water W flowing into the bearing portion 15 flows downward through a gap between the bearing portion 15 and the fixed shaft 30 in the radial direction or the first groove portion 15a, and flows into a portion positioned below the first groove portion 15a in the bearing portion 15. The water W flowing into the portion positioned below the first groove portion 15a in the bearing portion 15 flows radially outward through a gap between the bearing portion 15 and a washer 32 described below in the axial direction or the second groove portion 15b, and flows into the impeller 40.

As shown in FIG. 8, the second housing 70 includes a second welding fixing portion 77 provided on an upper surface of the second housing 70. In the present embodiment, the second welding fixing portion 77 is a groove bottom surface of an annular groove 72a provided on an upper surface of the annular wall portion 72. The second welding fixing portion 77 has an annular shape surrounding the central axis J. More specifically, the second welding fixing portion 77 has an annular shape centered on the central axis J. As shown in FIG. 1, the second welding fixing portion 77 is in contact with the first welding fixing portion 67. The second welding fixing portion 77 is fixed to the first welding fixing portion 67 by welding. That is, the second welding fixing portion 77 is a welding fixing portion fixed to the first housing 60 by welding. A welding method for fixing the first welding fixing portion 67 and the second welding fixing portion 77 to each other is not particularly limited. As the welding method for fixing the first welding fixing portion 67 and the second welding fixing portion 77 to each other, for example, infrared welding, ultrasonic welding, laser welding, spin welding, or the like can be adopted.

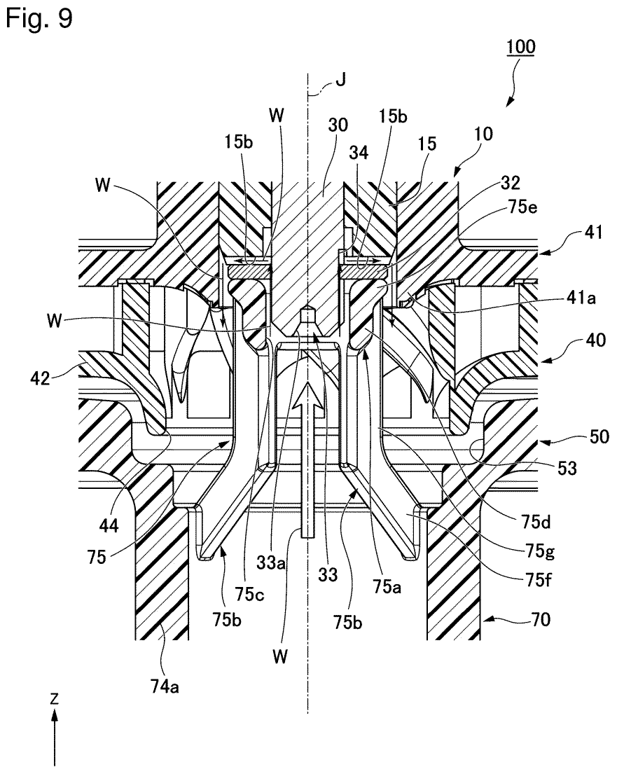

As shown in FIG. 9, the second housing 70 includes a rotor supporting portion 75 that supports the rotor 10 from below. That is, the housing 50 includes the rotor supporting portion 75. The rotor supporting portion 75 includes a support body portion 75a and a plurality of leg portions 75b. The support body portion 75a supports the rotor 10. In the present embodiment, the support body portion 75a supports the rotor 10 from below via the washer 32. The fixed shaft 30 passes on an inner side of the washer 32 in the axial direction. That is, the pump 100 includes the washer 32 surrounding the fixed shaft 30. The washer 32 has a substantially annular shape centered on the central axis J. The washer 32 has a plate shape whose plate surface faces the axial direction. The washer 32 is provided between the rotor supporting portion 75 and the rotor 10. In the present embodiment, the washer 32 is provided between the support body portion 75a and the bearing portion 15 in the axial direction. The washer 32 is in contact with an upper end portion of the support body portion 75a and the lower end portion of the bearing portion 15. Thus, the rotor 10 can be suitably supported by the support body portion 75a via the washer 32.

As shown in FIG. 6, a portion of the fixed shaft 30 in which the flat surface 34 is provided on the outer circumferential surface passes on the inner side of the washer 32 in the axial direction. A linear portion 32a that is in contact with the flat surface 34 in the radial direction or faces the flat surface 34 via a gap is provided at an inner edge of the washer 32. As the linear portion 32a is provided, an inner edge shape of the washer 32 is substantially the same as an outer edge shape of the portion of the fixed shaft 30 in which the flat surface 34 is provided when viewed in the axial direction. When the washer 32 attempts to rotate relative to the fixed shaft 30 in the circumferential direction, the linear portion 32a of the washer 32 comes into contact with an edge portion of the flat surface 34 in the circumferential direction. As a result, the washer 32 is caught by the fixed shaft 30 in the circumferential direction. Therefore, the washer 32 is prevented from rotating in the circumferential direction around the central axis J with respect to the fixed shaft 30. Therefore, it is possible to prevent the washer 32 from being rubbed against the rotor supporting portion 75. As a result, it is possible to suppress wear of the rotor supporting portion 75 even in a case where a wear resistance of a portion of the rotor supporting portion 75 that comes into contact with the washer 32 is lower than a wear resistance of a portion of the rotor 10 that comes into contact with the washer 32. Therefore, it is easy to use a relatively inexpensive material as a material of the rotor supporting portion 75, and it is possible to suppress an increase in manufacturing cost of the pump 100. Further, since the washer 32 can be prevented from rotating relative to the fixed shaft 30 in the circumferential direction by passing the washer 32 through the fixed shaft 30, an assembly of the pump 100 can be facilitated as compared with a case where the washer 32 is fixed to the fixed shaft 30 with a screw or the like.

As shown in FIG. 9, a through hole 75c penetrating through the support body portion 75a in the axial direction is provided in the support body portion 75a. That is, the rotor supporting portion 75 has the through hole 75c penetrating through the rotor supporting portion 75 in the axial direction. In the present embodiment, the through hole 75c has a circular shape centered on the central axis J when viewed in the axial direction. An inner diameter of the through hole 75c is larger than the outer diameter of the fixed shaft 30. The inner diameter of the through hole 75c is larger than an inner diameter of the washer 32. As the through hole 75c is provided, the support body portion 75a has a tubular shape that is open to both sides in the axial direction. In the present embodiment, the support body portion 75a has a substantially cylindrical shape that is centered on the central axis J and is open to both sides in the axial direction.

The support body portion 75a includes a small-diameter portion 75d and a large-diameter portion 75e. The small-diameter portion 75d is a lower portion of the support body portion 75a. The large-diameter portion 75e is an upper portion of the support body portion 75a. The large-diameter portion 75e is connected to an upper side of the small-diameter portion 75d. An outer diameter of the large-diameter portion 75e is larger than an outer diameter of the small-diameter portion 75d. The outer diameter of the large-diameter portion 75e is substantially the same as an outer diameter of the washer 32. A lower surface of the washer 32 is in contact with an upper end surface of the large-diameter portion 75e.

At least a part of the support body portion 75a is positioned in the interior of the impeller 40. In the present embodiment, the entire support body portion 75a is positioned in the interior of the impeller 40. The interior of the impeller 40 includes the interior of the radially inner edge portion 41a of the base portion 41. The large-diameter portion 75e of the support body portion 75a is positioned in the interior of the radially inner edge portion 41a. A radially outer surface of the large-diameter portion 75e is provided so as to be separated radially inward from a radially inner surface of the radially inner edge portion 41a. The small-diameter portion 75d of the support body portion 75a is positioned below the radially inner edge portion 41a and is positioned above the second suction port 44.

The lower end portion of the fixed shaft 30 is inserted into the support body portion 75a, that is, into the through hole 75c. As a result, the lower end portion of the fixed shaft 30 is exposed to the interior of the impeller 40 through a lower opening of the through hole 75c. The lower opening of the through hole 75c overlaps the second suction port 44 when viewed in the axial direction. As a result, a part of the fixed shaft 30 is exposed to the second suction port 44. Therefore, the water W flowing into the impeller 40 from the second suction port 44 can be brought into contact with a part of the fixed shaft 30 exposed to the second suction port 44. Therefore, even in a case where heat is generated by friction between the fixed shaft 30 and the rotor 10 due to the rotation of the rotor 10, the heat can be easily released from the fixed shaft 30 to the water W. Thus, heat dissipation of the fixed shaft 30 can be improved.

In the present specification, it is sufficient if an expression “a part of the fixed shaft is exposed to the second suction port” means that a part of the fixed shaft is visually recognizable when the interior of the second suction port is viewed from a side where the second suction port is open. In the present embodiment, an entire lower surface of the fixed shaft 30 is visually recognizable when the second suction port 44 is viewed from the side where the second suction port 44 is open, that is, from below. That is, in the present embodiment, the entire lower surface of the fixed shaft 30 is exposed to the second suction port 44. In the present specification, the expression “a part of the fixed shaft is exposed to the second suction port” includes a case where a part of the fixed shaft is positioned in the interior of the second suction port.

In the present embodiment, the second suction port 44 is disposed above the first suction port 74a. Therefore, the water W flowing into the impeller accommodating portion 53 from the first suction port 74a easily flows into the second suction port 44. Accordingly, it is easy to bring the water W into contact with a part of the fixed shaft 30 exposed to the second suction port 44. Accordingly, the heat dissipation of the fixed shaft 30 can be further improved.

In the present embodiment, the fixed shaft 30 has the recess 33 provided at the portion of the fixed shaft 30 that is exposed to the second suction port 44. Therefore, a surface area of the portion of the fixed shaft 30 that is exposed to the second suction port 44 can be increased by the recess 33. As a result, an area of the portion of the fixed shaft 30 that is exposed to the second suction port 44 and comes into contact with the water W can be increased. Therefore, heat can be easily released from the fixed shaft 30 to the water W. Therefore, the heat dissipation of the fixed shaft 30 can be further improved.

In the present embodiment, the recess 33 is recessed upward from the lower end surface of the fixed shaft 30. Therefore, a part of the water W sucked from the second suction port 44 can be more easily brought into contact with the recess 33. As a result, heat can be more easily transferred from the fixed shaft 30 to the water W. Accordingly, the heat dissipation of the fixed shaft 30 can be further improved.

In the present embodiment, at least a part of the fixed shaft 30 overlaps the through hole 75c when viewed in the axial direction. Therefore, a part of the fixed shaft 30 can be suitably exposed to the second suction port 44 through the through hole 75c.

In the present specification, an expression “a certain object overlaps another object when viewed in a certain direction” means that the certain object is disposed at the same position as at least a part of the other object when viewed in the certain direction. That is, the expression “at least a part of the fixed shaft 30 overlaps the through hole 75c when viewed in the axial direction” means that at least a part of the fixed shaft 30 is disposed at the same position as at least a part of the through hole 75c when viewed in the axial direction.

In the present embodiment, the inner diameter of the through hole 75c is larger than the outer diameter of the fixed shaft 30, and the entire fixed shaft 30 overlaps the through hole 75c when viewed in the axial direction. Therefore, a part of the fixed shaft 30 can be more suitably exposed to the second suction port 44 through the through hole 75c. In addition, since the inner diameter of the through hole 75c is larger than the outer diameter of the fixed shaft 30, the water W can easily flow into the through hole 75c. As a result, the water W can be more easily brought into contact with the fixed shaft 30 through the through hole 75c. Accordingly, the heat dissipation of the fixed shaft 30 can be further improved.

In the present embodiment, the lower end portion of the fixed shaft 30 is positioned in the through hole 75c. Therefore, the fixed shaft 30 can be prevented from protruding downward from the through hole 75c. As a result, the flow of the water W in the interior of the impeller 40 is hardly inhibited by the lower end portion of the fixed shaft 30. Therefore, it is possible to suppress a decrease in efficiency of the pump 100. In addition, the water W flowing into the through hole 75c from the second suction port 44 can be easily brought into suitable contact with the fixed shaft 30. Therefore, the heat dissipation of the fixed shaft 30 can be further improved.

The plurality of leg portions 75b connect the support body portion 75a and an inner surface of the impeller accommodating portion 53. As shown in FIG. 8, in the present embodiment, three leg portions 75b are provided at intervals in the circumferential direction. The number of leg portions 75b is not particularly limited. The plurality of leg portions 75b are arranged at equal intervals over the entire circumference in the circumferential direction. In the present embodiment, the plurality of leg portions 75b extend upward from an inner circumferential surface of the first suction port 74a. Upper end portions of the plurality of leg portions 75b are connected to the support body portion 75a.

As shown in FIG. 9, each of the plurality of leg portions 75b includes a first extending portion 75f and a second extending portion 75g. The first extending portion 75f extends radially inward and upward from the inner circumferential surface of the first suction port 74a. A lower surface of the first extending portion 75f faces the interior of the first suction port 74a. The lower surface of the first extending portion 75f is a flat inclined surface positioned on an upper side as proceeding to a radially inner side. The second extending portion 75g extends upward from a radially inner and upper end portion of the first extending portion 75f. An upper end portion of the second extending portion 75g is connected to the support body portion 75a. An upper portion of the second extending portion 75g is inserted to the interior of the impeller 40 from the second suction port 44.

In the present embodiment, the support body portion 75a can be disposed at a suitable position for supporting the rotor 10 by the plurality of leg portions 75b. Since the through hole 75c is provided in the support body portion 75a, the through hole 75c can be easily disposed at a position overlapping the fixed shaft 30 in the axial direction by the plurality of leg portions 75b. As a result, a part of the fixed shaft 30 can be easily exposed to the second suction port 44 through the through hole 75c. In addition, since the support body portion 75a is supported by the plurality of leg portions 75b, the plurality of leg portions 75b supporting the support body portion 75a in the impeller accommodating portion 53 are less likely to interfere with (resist against) the flow of the water W as compared with a case where the support body portion 75a is supported by a cylindrical support portion, for example.

In the present embodiment, the water W flowing into the impeller accommodating portion 53 from the first suction port 74a flows upward and flows into the impeller 40 from the second suction port 44. A part of the water W flowing into the impeller 40 flows upward as it is and flows into the through hole 75c. The water W flowing into the through hole 75c is brought into contact with a portion of the fixed shaft 30 positioned in the through hole 75c, and heat is released from the fixed shaft 30 to the water W. At least a part of the water W flowing into the through hole 75c flows from between the fixed shaft 30 and the washer 32 to an upper side of the washer 32. The water W flowing to the upper side of the washer 32 flows radially outward in the second groove portion 15b and flows to a lower side of the radially inner edge portion 41a of the base portion 41 via a gap between the washer 32 and the support body portion 75a and the radially inner edge portion 41a of the base portion 41 in the radial direction. The water W flowing to the lower side of the radially inner edge portion 41a flows radially outward and is discharged from the second discharge port 45 to the outside of the impeller 40.

As shown in FIG. 2, the holding member 80 is positioned above the stator 20. The holding member 80 is supported from below by the stator 20. In the present embodiment, the holding member 80 is made of a resin. At least a part of the holding member 80 is embedded and held in the first housing 60. In the present embodiment, substantially the entire holding member 80 is embedded in the first housing 60. The holding member 80 holds the conductive member 90. The conductive member 90 is made of metal. In the present embodiment, the conductive member 90 is a sheet metal member. In the present embodiment, a plurality of conductive members 90 are provided at intervals in the circumferential direction. The conductive member 90 electrically connects the coil 23 and the board 95. A part of the conductive member 90 is embedded and held in the first housing 60.

The board 95 is accommodated in the housing 50. More specifically, the board 95 is accommodated in the board accommodating portion 65. The board 95 is, for example, a printed wiring board. In the present embodiment, an inverter circuit that supplies power to the coil 23 is provided on the board 95. A plate surface of the board 95 faces the axial direction. The plate surface of the board 95 is, for example, orthogonal to the axial direction. The board 95 has, for example, a substantial disc shape. The board 95 is supported from below by a protruding supporting portion 68 provided in the interior of the board accommodating portion 65.

The plurality of electronic components 96 are attached to the board 95. The plurality of electronic components 96 include a first electronic component 96a, a second electronic component 96b, and a third electronic component 96c. In the present embodiment, the first electronic component 96a is attached to an upper surface of the board 95. The first electronic component 96a is, for example, a field effect transistor (FET) implementing the inverter circuit. The first electronic component 96a overlaps the first partition portion 69a when viewed in the axial direction.

The second electronic component 96b is attached to a lower surface of the board 95. The second electronic component 96b is an electronic component 96 having a larger axial dimension than the first electronic component 96a. The second electronic component 96b is, for example, an electrolytic capacitor. The second electronic component 96b has, for example, a substantially columnar shape protruding downward from the lower surface of the board 95. The second electronic component 96b overlaps the second partition portion 69b when viewed in the axial direction. A lower portion of the second electronic component 96b is inserted into a third recess 69j. A lower end portion of the second electronic component 96b is positioned below the upper end portion of the shaft holding portion 69c, and is positioned radially outside the shaft holding portion 69c. In the present embodiment, the lower end portion of the second electronic component 96b is positioned below the upper end portion of the fixed shaft 30, and is positioned radially outside the fixed shaft 30. The lower end portion of the second electronic component 96b is disposed away upward from an upper surface of the second partition portion 69b.

The third electronic component 96c is attached to the lower surface of the board 95. The third electronic component 96c is an electronic component 96 having a larger axial dimension than the first electronic component 96a and a smaller axial dimension than the second electronic component 96b. The third electronic component 96c is, for example, a choke coil. The third electronic component 96c overlaps the shaft holding portion 69c and the fixed shaft 30 when viewed in the axial direction. A lower end portion of the third electronic component 96c is disposed away upward from an upper surface of the shaft holding portion 69c.

A heat conduction member 120 that is in contact with the partition portion 69 and the board 95 is provided between the partition portion 69 and the board 95. Therefore, heat of the board 95 can be transferred from the heat conduction member 120 to the partition portion 69. Since the partition portion 69 partitions between the interior of the rotor accommodating portion 64 and the interior of the board accommodating portion 65, the heat transmitted to the partition portion 69 is released to the water W flowing into the rotor accommodating portion 64. As a result, the heat of the board 95 can be released to the water W which is a fluid sent by the impeller 40. A fluid such as the water W has a higher thermal conductivity than air. Therefore, the heat dissipation of the board 95 can be improved as compared with a case where the heat of the board 95 is released to the air outside the pump 100. In the present embodiment, the heat transferred to the heat conduction member 120 is released to the water W in the rotor accommodating portion 64 via the first partition portion 69a and the second partition portion 69b.

In addition, for example, in a case where the heat of the board 95 is released to the air outside the pump 100, a heat sink or the like may be provided on an outer surface of the housing 50 in order to improve the heat dissipation. On the other hand, according to the present embodiment, since heat can be released to the water W having a higher thermal conductivity than air, the heat dissipation of the board 95 can be improved without providing a heat sink or the like. Therefore, it is possible to improve the heat dissipation of the board 95 while suppressing an increase in the number of components of the pump 100.

In the present embodiment, as described above, the heat of the fixed shaft 30 can be easily released to the water W. Therefore, a part of the heat transferred from the board 95 to the partition portion 69 via the heat conduction member 120 is easily released from the shaft holding portion 69c to the water W via the fixed shaft 30. As a result, the heat dissipation of the board 95 can be further improved.

In the present embodiment, the heat conduction member 120 is made of a heat dissipation gap filler. Therefore, the heat dissipation gap filler is applied in the board accommodating portion 65 in an uncured state, and the board 95 to which the plurality of electronic components 96 are attached is disposed in the board accommodating portion 65 while being pressed against the applied uncured heat dissipation gap filler, whereby the board 95 can be suitably brought into close contact with the uncured heat dissipation gap filler. In addition, the electronic components 96 attached to the lower surface of the board 95 are easily embedded in the uncured heat dissipation gap filler, and the electronic components 96 attached to the lower surface of the board 95 can be suitably brought into close contact with the heat dissipation gap filler. In a state in which the board 95 and the electronic components 96 attached to the lower surface of the board 95 are in close contact with the heat dissipation gap filler, the heat dissipation gap filler is cured to form the heat conduction member 120, whereby the board 95 and the electronic components 96 attached to the lower surface of the board 95 can be suitably brought into contact with the heat conduction member 120. Therefore, heat can be easily transferred suitably from the board 95 and the electronic components 96 to the heat conduction member 120, and the heat dissipation of the board 95 can be further improved.

In the present embodiment, a worker or the like who installs the board 95 in the board accommodating portion 65 applies the uncured heat dissipation gap filler onto the partition portion 69 with a dispenser or the like, and then brings the board 95 to which the plurality of electronic components 96 are attached close to the applied uncured heat dissipation gap filler from above. The worker or the like causes the board 95 to be supported by the protruding supporting portion 68 from below while pressing the board 95 against the uncured heat dissipation gap filler, and fixes the board 95 in the board accommodating portion 65. At this time, the second electronic component 96b and the third electronic component 96c attached to the lower surface of the board 95 are embedded in the uncured heat dissipation gap filler. Thereafter, the worker or the like cures the uncured heat dissipation gap filler to form the heat conduction member 120 that is in contact with the partition portion 69 and the board 95. A method of curing the uncured heat dissipation gap filler can be appropriately adopted according to a material of the heat dissipation gap filler.

Note that, in the present specification, the “worker or the like” includes a worker, an assembling device, and the like that perform each work. Each piece of work may be performed only by the worker, may be performed only by the assembly device, or may be performed by the worker and the assembly device.

The heat dissipation gap filler forming the heat conduction member 120 has such a viscosity at which the applied shape can be maintained unless an external force is applied when the heat dissipation gap filler is applied in an uncured state, for example. The heat dissipation gap filler forming the heat conduction member 120 is an elastically deformable material in a cured state. The heat dissipation gap filler forming the heat conduction member 120 in a cured state is in a state like rubber or clay. The heat dissipation gap filler forming the heat conduction member 120 is a material obtained by mixing a plurality of fillers having a thermal conductivity with a resin. The resin forming the heat dissipation gap filler is, for example, silicone. The filler forming the heat dissipation gap filler is, for example, ceramic. A material of the heat dissipation gap filler is not particularly limited.

The thermal conductivity of the heat dissipation gap filler forming the heat conduction member 120 is higher than a thermal conductivity of a material of the partition portion 69. The thermal conductivity of the heat dissipation gap filler forming the heat conduction member 120 is, for example, 1.5 W/(m·K) or more and 5 W/(m·K) or less. The thermal conductivity of the material of the partition portion 69 is, for example, 0.2 W/(m·K) or more and 0.35 W/(m·K) or less. In the present embodiment, the material of the partition portion 69 is a material of the housing 50, and is a resin.

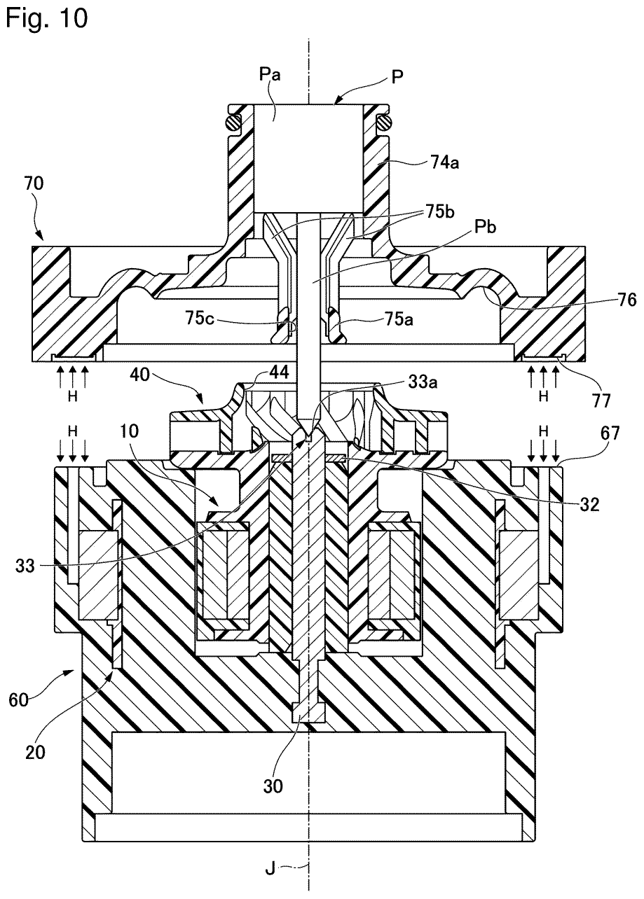

A method of manufacturing the pump 100 according to the present embodiment described above includes an assembly process of fixing the first housing 60 and the second housing 70. As shown in FIG. 10, the worker or the like assembles the rotor 10 and the impeller 40 to the first housing 60, and fixes the first housing 60 and the second housing 70 to each other by welding. In the present embodiment, before the first housing 60 and the second housing 70 are brought into contact with each other, the first welding fixing portion 67 in the first housing 60 and the second welding fixing portion 77 in the second housing 70 are melted by heat H. By bringing the melted first welding fixing portion 67 and second welding fixing portion 77 into contact with each other in the axial direction, the first housing 60 and the second housing 70 can be fixed by welding.

In the present embodiment, when fixing the first housing 60 and the second housing 70, the worker or the like brings the first housing 60 and the second housing 70 close to each other in the axial direction while positioning the second housing 70 with respect to the first housing 60 by using a jig P. At this time, for example, the worker or the like disposes the first housing 60 on a lower side in a vertical direction, and relatively brings the second housing 70 close to the first housing 60 from an upper side in the vertical direction. Accordingly, it is possible to prevent the washer 32 surrounding the fixed shaft 30 from falling downward in the vertical direction.

The jig P includes a base portion Pa and a pin portion Pb. The base portion Pa has a columnar shape centered on the central axis J. The pin portion Pb extends in the axial direction from the base portion Pa. A tip of the pin portion Pb has a conical shape. The base portion Pa is fitted into the first suction port 74a. Thus, the jig P can be positioned in the radial direction with respect to the second housing 70. The pin portion Pb passes through the through hole 75c in the axial direction and is inserted into the impeller 40 from the second suction port 44. A tip portion of the pin portion Pb is fitted into the recess 33 provided at an end portion of the fixed shaft 30 in the axial direction. More specifically, the tip of the pin portion Pb is fitted into the tapered portion 33a of the recess 33. Thus, the jig P can be positioned in the radial direction with respect to the fixed shaft 30. Therefore, the fixed shaft 30 and the second housing 70 can be positioned in the radial direction with respect to each other via the jig P, and the second housing 70 can be disposed with high axial accuracy with respect to the fixed shaft 30. In this state, the worker or the like brings the first housing 60 and the second housing 70 close to each other, and fixes the first housing 60 and the second housing 70 to each other by welding.

As described above, in the present embodiment, since the through hole 75c is provided in the rotor supporting portion 75, it is possible to adopt an assembling method in which the first housing 60 and the second housing 70 are brought close to each other while positioning is performed by passing the pin portion Pb of the jig P through the through hole 75c and fitting the tip of the pin portion Pb into the recess 33 of the fixed shaft 30. As a result, the second housing 70 can be fixed to the first housing 60 via the jig P in a state in which the second housing 70 is disposed with high axial accuracy with respect to the fixed shaft 30. The fixed shaft 30 rotatably supports the rotor 10, and the impeller 40 is connected to an end portion of the rotor 10 in the axial direction. Therefore, the rotor 10 and the impeller 40 are positioned in the radial direction with respect to the fixed shaft 30. The flow path portion 76 extending in the circumferential direction and positioned radially outside the impeller 40 is provided in the second housing 70. Therefore, since the second housing 70 can be disposed with high axial accuracy with respect to the fixed shaft 30, the impeller 40 and the flow path portion 76 can be arranged with high axial accuracy. Therefore, the water W can easily flow from the impeller 40 into the flow path portion 76, and efficiency of the pump 100 can be improved.

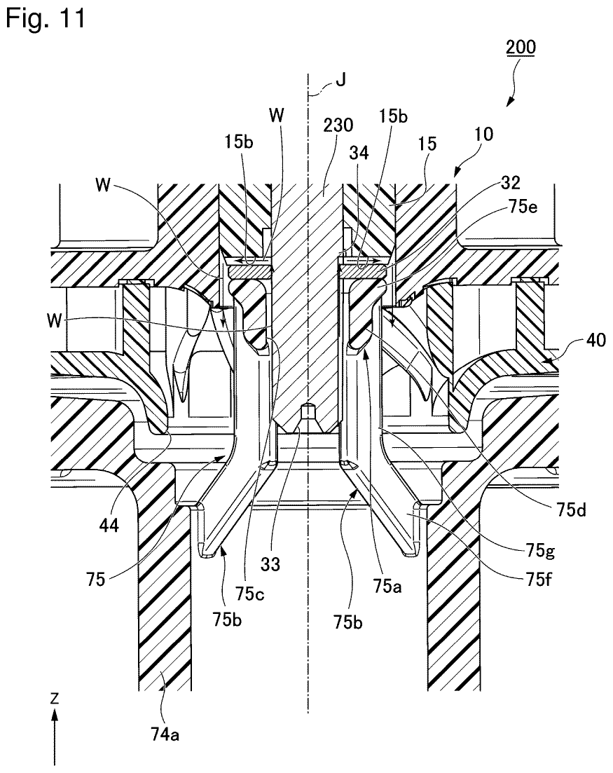

As shown in FIG. 11, in a pump 200 according to the present embodiment, a fixed shaft 230 passes through a through hole 75c provided in a rotor supporting portion 75. A lower end portion of the fixed shaft 230 is positioned below the through hole 75c. Therefore, it is easy to increase an area of a portion of the fixed shaft 230 that is exposed to an interior of an impeller 40. As a result, an area of the fixed shaft 230 in contact with water W can be increased. Therefore, it is easier to release heat of the fixed shaft 230 to the water W. Therefore, heat dissipation of the fixed shaft 230 can be further improved. Other configurations of the fixed shaft 230 are similar to the other configurations of the fixed shaft 30 in the first embodiment. Other configurations of the pump 200 are similar to the other configurations of the pump 100 in the first embodiment.

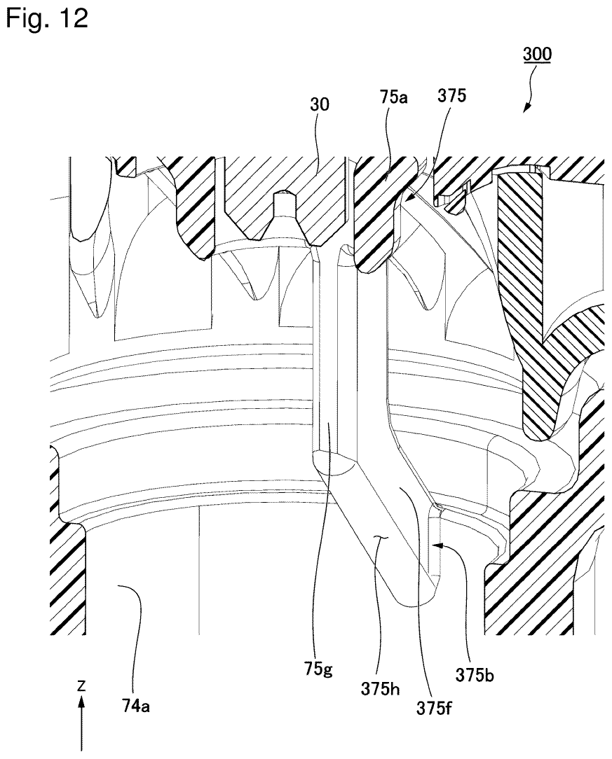

As shown in FIG. 12, in a pump 300 according to the present embodiment, a leg portion 375b of the rotor supporting portion 375 has a curved surface 375h facing an interior (inner side) of a first suction port 74a. Therefore, it is easy to reduce a resistance of the leg portion 375b against water W flowing from the first suction port 74a. As a result, it is possible to further suppress a flow of the water W from being inhibited by the leg portion 375b even in a case where the leg portion 375b is provided. In the present embodiment, the curved surface 375h is a lower surface of a first extending portion 375f. The curved surface 375h is a semicircular arcuate surface protruding downward when viewed in a direction in which the first extending portion 375f extends. The curved surface 375h is positioned on an upper side as proceeding to a radially inner side. Other configurations of the leg portion 375b are similar to the other configurations of the leg portion 75b in the first embodiment. Although not shown, in the present embodiment, each of a plurality of leg portions 375b has the curved surface 375h. Other configurations of the rotor supporting portion 375 are similar to the other configurations of the rotor supporting portion 75 in the first embodiment. Other configurations of the pump 300 are similar to the other configurations of the pump 100 in the first embodiment.

The present invention is not limited to the above-described embodiments, and other configurations and methods can be adopted within the scope of the technical idea of the present invention. A part of the fixed shaft may be exposed by any structure as long as a part of the fixed shaft is exposed to the second suction port of the impeller. For example, a part of the fixed shaft may be exposed to the second suction port by implementing the rotor supporting portion only with a plurality of leg portions. In this case, the rotor is supported by the end portions on the other side (upper side) of the plurality of leg portions in the axial direction. In a case where the through hole penetrating through the rotor supporting portion in the axial direction is provided in the rotor supporting portion, the fixed shaft does not have to be inserted into the through hole. For example, the end portion on one side (lower side) of the fixed shaft in the axial direction may be positioned on the other side (upper side) of the through hole in the axial direction. The recess does not have to be provided in the portion of the fixed shaft that is exposed to the second suction port. The first suction port that is open to the interior of the impeller accommodating portion may be provided at any position. The washer surrounding the fixed shaft does not have to be provided.

The application of the pump to which the present invention is applied is not particularly limited. The pump may be mounted on any device. The pump may be mounted on a vehicle, for example. The pump may be a pump that sends any fluid. The pump may be an oil pump that sends oil.

Note that the present technique can have a configuration as described below. (1) A pump including: a rotor that is rotatable about a central axis; a stator that radially faces the rotor with a gap interposed therebetween; an impeller that is connected to one side of the rotor in an axial direction; a housing that includes a rotor accommodating portion that accommodates the rotor therein; and a fixed shaft that extends in the axial direction and rotatably supports the rotor, in which the housing includes: a rotor supporting portion that supports the rotor from one side in the axial direction; an impeller accommodating portion that accommodates the impeller therein and has an interior connected to an interior of the rotor accommodating portion; and a first suction port that is open to the interior of the impeller accommodating portion, the impeller includes a second suction port that is open to one side in the axial direction, and a part of the fixed shaft is exposed to the second suction port. (2) The pump according to (1), in which the rotor supporting portion has a through hole penetrating through the rotor supporting portion in the axial direction, and at least a part of the fixed shaft overlaps the through hole when viewed in the axial direction. (3) The pump according to (2), in which an inner diameter of the through hole is larger than an outer diameter of the fixed shaft, and the entire fixed shaft overlaps the through hole when viewed in the axial direction. (4) The pump according to (3), in which an end portion on one side of the fixed shaft in the axial direction is positioned in the through hole. (5) The pump according to (3), in which the fixed shaft passes through the through hole, and the end portion on one side of the fixed shaft in the axial direction is positioned on one side of the through hole in the axial direction. (6) The pump according to any one of (2) to (5), in which the rotor supporting portion includes: a support body portion that supports the rotor; and a plurality of leg portions that connect the support body portion and an inner surface of the impeller accommodating portion, and the through hole is provided in the support body portion. (7) The pump according to (6), in which the leg portion has a curved surface facing an interior of the first suction port. (8) The pump according to any one of (1) to (7), in which the second suction port is disposed on the other side of the first suction port in the axial direction. (9) The pump according to any one of (1) to (8), in which the fixed shaft has a recess provided at a portion of the fixed shaft that is exposed to the second suction port. (10) The pump according to (9), in which the recess is recessed from an end surface on one side of the fixed shaft in the axial direction toward the other side in the axial direction. (11) The pump according to any one of (1) to (10), further including a washer surrounding the fixed shaft, in which the washer is provided between the rotor supporting portion and the rotor, and is caught by the fixed shaft in a circumferential direction.

The configurations and methods described above in the present description can be appropriately combined within a range consistent with each other.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A pump comprising:
a rotor that is rotatable about a central axis;
a stator that radially faces the rotor with a gap interposed therebetween;
an impeller that is connected to one side of the rotor in an axial direction;
a housing that includes a rotor accommodating portion that accommodates the rotor therein; and
a fixed shaft that extends in the axial direction and rotatably supports the rotor,
wherein the housing includes:
a rotor supporting portion that supports the rotor from one side in the axial direction;
an impeller accommodating portion that accommodates the impeller therein and has an interior connected to an interior of the rotor accommodating portion; and
a first suction port that is open to the interior of the impeller accommodating portion,
the impeller includes a second suction port that is open to one side in the axial direction, and
a part of the fixed shaft is exposed to the second suction port.

2. The pump according to claim 1, wherein
the rotor supporting portion has a through hole penetrating through the rotor supporting portion in the axial direction, and
at least a part of the fixed shaft overlaps the through hole when viewed in the axial direction.

3. The pump according to claim 2, wherein
an inner diameter of the through hole is larger than an outer diameter of the fixed shaft, and
the entire fixed shaft overlaps the through hole when viewed in the axial direction.

4. The pump according to claim 3, wherein an end portion on one side of the fixed shaft in the axial direction is positioned in the through hole.

5. The pump according to claim 3, wherein
the fixed shaft passes through the through hole, and
the end portion on one side of the fixed shaft in the axial direction is positioned on one side of the through hole in the axial direction.

6. The pump according to claim 2, wherein
the rotor supporting portion includes:
a support body portion that supports the rotor; and
a plurality of leg portions that connect the support body portion and an inner surface of the impeller accommodating portion, and
the through hole is provided in the support body portion.

7. The pump according to claim 6, wherein the leg portion has a curved surface facing an interior of the first suction port.

8. The pump according to claim 1, wherein the second suction port is disposed on the other side of the first suction port in the axial direction.

9. The pump according to claim 1, wherein the fixed shaft has a recess provided at a portion of the fixed shaft that is exposed to the second suction port.

10. The pump according to claim 9, wherein the recess is recessed from an end surface on one side of the fixed shaft in the axial direction toward the other side in the axial direction.

11. The pump according to claim 1, further comprising
a washer surrounding the fixed shaft,
wherein the washer is provided between the rotor supporting portion and the rotor, and is caught by the fixed shaft in a circumferential direction.
